(19) United States
(12) Patent Application Publication
(10) Pub. No.: US 2004/0015882 A1
(43) Pub. Date: Jan. 22, 2004

(54) Branch-free software methodology for transcendental functions

(76) Inventor: Ping Tak Peter Tang, Hayward, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/875,464

(22) Filed: Jun. 5, 2001

(51) Int. Cl. G06F 9/44

(52) U.S. Cl. 717/129; 717/130

(57) ABSTRACT

Various embodiments of a computer-implemented branch-free methodology for approximating a function of an input argument are disclosed. The methodology includes selecting one of a number of breakpoints, such that a reduced argument for the function is less than a predetermined value. An approximate function of the reduced argument is evaluated, including accessing a look-up table based on the selected breakpoint to obtain value of a term in the approximate function. The look-up table has at least one breakpoint for which the reduced argument can be computed without roundoff error when the input argument is close to a root of the function. The branch-free methodology may be applied to compute transcendental functions such as the exponential, logarithm, and trigonometric functions.

### BACKGROUND

This invention is related to software methodologies for computing transcendental functions.

The fast and accurate evaluation of transcendental functions such as exponentials, logarithms, and trigonometric functions and their inverses, is highly desirable in many fields of scientific and engineering computing. Software implementations of these are typically written in assembly language code and use look-up tables to approximate one or more intermediate values in the computation, for faster evaluation of the function.

A typical software implementation of the general base logarithm function log_{b}(X) starts with representing X, a positive real number, in the floating point form Y G^{k} where Y is a positive real number greater than or equal to 1 and less than G, G is a positive integer, and k (the exponent) is an integer. The limits on Y, G, and k depend on the hardware capabilities of the data processor that is executing the software. The software also includes a predefined look-up table which gives values of log_{b}(1/Bⱼ) that have been previously computed for a number of breakpoints B₀>B₁> . . . >B_{N}(Bⱼ). Depending on the input X, a breakpoint Bⱼ is selected so that |Y*Bⱼ−1| is less than a predetermined value, delta. In general, Bⱼ is selected to approximate 1/Y to a short precision. The function log_{b}(X) is then computed via the relationship:

log_{b}(X)≈k log_{b}(2)+log_{b}(1/Bⱼ)+log_{b}(1+(Y Bⱼ−1))

The third term can be computed using conventional polynomial approximations. The logarithm function is implemented in this manner to improve the accuracy of the result as well as its speed of computation. This methodology is depicted by the operations 104, 108, 112, and 116 in the right-hand column of FIG. 1 which shows a flow diagram of a conventional methodology for computing the logarithm.

Due to the finite numerical precision that is available for representing numbers in a machine, arithmetic operations performed by the machine can result in roundoff error, caused by either truncation of or rounding up (or down) a result of the arithmetic operation. Under certain situations, such as when the argument lies very close to a root of the function, alternative numerical techniques are used to limit the severity of the roundoff error. Thus, rather than follow the general relationship, in operations 104-116 described in the previous paragraph, a completely different relationship is used to compute log_{b}(X) when X is very close to 1. This other relationship is depicted by the operations 120, 124, and 128 in the left-hand column of FIG. 1.

A problem with using two very different software flows, such as the two depicted in FIG. 1, for computing a function is that a test and branch instruction, as in operation 102, is needed to implement the decision as to which flow to take. Even a single branch can cause severe performance penalties when a complex program is being executed. In certain modern computer architectures that have deep pipelines, and thus aggressive instruction prefetching, branch mispredictions can cause a large, filled pipeline to be drained, thereby rendering the instruction prefetching a waste. Also, if the architecture allows significant parallel data processing, branch-free table look-up implementations can offer a significant performance improvement.

### BRIEF DESCRIPTION OF THE DRAWINGS

The invention is illustrated by way of example and not by way of limitation in the figures of the accompanying drawings in which like references indicate similar elements. It should be noted that references to “an” embodiment in this disclosure are not necessarily to the same embodiment, and they mean at least one.

FIG. 1 shows a diagram of a conventional dual flow with branch methodology for computing log_{b}(X).

FIG. 2 shows a diagram of a branch-free methodology for computing the logarithm function.

FIG. 3 illustrates a diagram of a branch-free methodology for computing the natural logarithm.

FIG. 4 depicts a diagram of a branch-free methodology for computing the base 10 logarithm function.

FIG. 5 depicts a block diagram of a computer system for implementing the branch-free methodology of computing a transcendental function.

### DETAILED DESCRIPTION

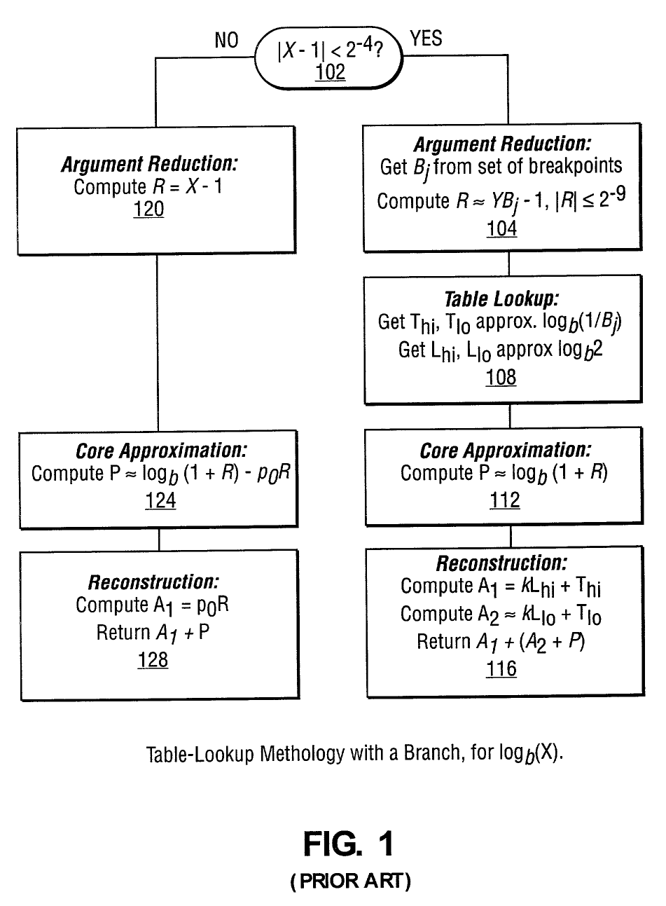

A computer-implemented method is described for approximating a function of an input argument. The method can be implemented by a single software flow, which helps eliminate heavy branch misprediction penalties associated with the conventional dual flow methodology. This branch-free methodology may be applied to compute transcendental functions such as the exponential, logarithm, and trigonometric functions. According to an embodiment of the invention, the conventional methodology is modified so that the lookup table has at least one breakpoint for which the reduced argument can be computed without roundoff error when the input argument is close to a root of the function. This modification helps avoid the loss of precision encountered during the right-hand flow of FIG. 1 when the input argument is closer to 1 by less than, for instance, 2⁻⁹. The modified breakpoint values allow the same flow to be used for all values of the input argument, even when close to a root of the function being evaluated.

Various embodiments of the branch-free methodology for computing a transcendental function are described below. These embodiments are based on representing X in the floating point form Y*G^{k} where Y is greater than or equal to 1. It should be noted, however, that other floating point forms may be used such as one in which Y lies between 0 and 1. For conciseness, however, the following embodiments are described using only the format in which Y lies in the range 1 to 2.

### EXAMPLE

General Base Logarithm

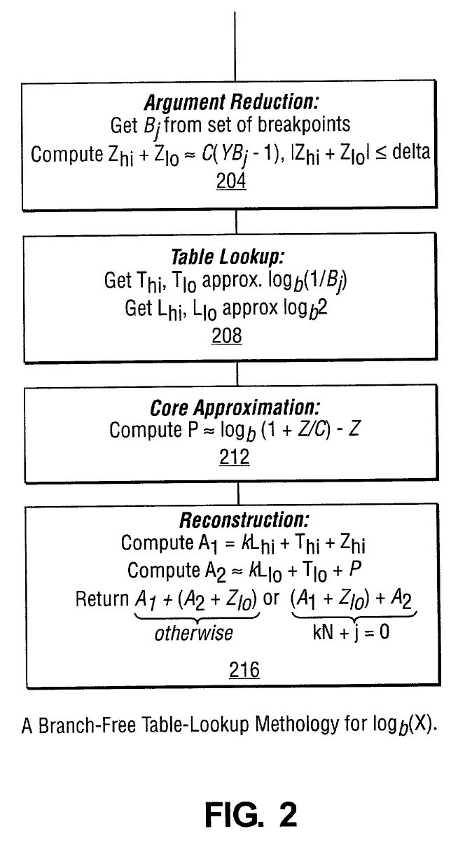

FIG. 2 shows a flow diagram, including operations 204-216, of a branch-free table-lookup methodology for computing log_{b}(X). The operations are discussed in more detail below.

Notation: Let the input argument be X=2^{k} ×Y, 1≦Y<2. Let C approximate the value log_{b}e to a short precision. Let B₀>B₁> . . . >B_{N} be a set of breakpoints such that for all Y there exists a j such that |YBⱼ−1|≦delta≈1/(2N).

Argument Reduction: Referring now to operation 204, find a suitable breakpoint Bⱼ and compute the reduced argument Z=C(YBⱼ−1).

Core Approximation: Returning now to operation 212, let P(Z) estimate the approximate function log_{b}(1+[Z/C])−Z to a relative accuracy comparable to roughly 2⁻⁵ epsilon, where epsilon is the machine's unit roundoff, e.g. 2⁻²⁴ for single precision or 2⁻⁵³ for double precision.

Reconstruction: The final result is k log_{b}2+log_{b}(1/Bⱼ)+Z+p(Z), computed in an appropriate way so as to maintain a desired level of numerical precision. The values log_{b} 2 and log_{b}(1/Bⱼ) are computed beforehand and stored in a table (see operation 208).

Note that in the Core Approximation step described above, the approximate function is log_{b}(1+[Z/C])−Z in terms of the variable Z, instead of a more straightforward approximation function log_{b}(1+R) in terms of the variable R=YBⱼ−1 as used in conventional techniques to compute the logarithm.

In the methodology described above, it should be noted that the sequence of breakpoints B₀, B₁ . . . B_{N} is arranged from the smallest to the largest to more quickly yield the selection Bⱼ that helps minimize the reduced argument |Y Bⱼ−1|. Once the reduced argument Z has been computed, the core approximation may be performed by evaluating the approximate function log_{b}(1+[Z/C])−Z using, for instance, a conventional polynomial approximation in Z.

As mentioned above, one or both of B₀ and B_{N} may be set such that the reduced argument can be computed without roundoff error. Generally, either B₀ or B_{N} is selected as the breakpoint when X is close to a root of the function being evaluated. Thus, taking the logarithm function as an example, its root is at X=1. Accordingly, as the value of X approaches 1, it may be expressed as either 1.000 . . . 001*2⁰ or 1.999 . . . 999*2⁻¹. If X is expressed by the former, then the selected breakpoint is B₀=1 when |Y−1| is less than delta. If the latter, then the breakpoint selected is B_{N}=1/2 when |Y−2| is less than delta.

To insure highest precision in approximating the function of X, the occurrence of roundoff errors should be minimized as much as possible. This may be accomplished by splitting each term of the approximate function into a pair of working-precision components whose sum is the value of that term. For the general base logarithm example given above, the value of log_{b}(2) is stored as a pair of working-precision numbers Lₕᵢ and Lₗₒ, and the values of log_{b}(1/Bⱼ) are stored in pairs of T_{j,hi} and T_{j,lo}. For the example given here, precision is improved if k Lₕᵢ+T_{j,hi} is representable exactly, that is without any roundoff errors, for all valid values of k and j. Consistent with Bⱼ=0, precision is also improved if T_{0,hi}=T_{0,lo}=0. Also, consistent with B_{N}=1/2, precision is further improved if T_{N,hi}=Lₕᵢ and TN_{,lo}=Lₗₒ. Finally, there can be a further improvement in precision if C, which approximates log_{b}e, is represented so that Z=C (YBⱼ−1) is computed without roundoff error when j=0 or j=N.

Together with the component representation described in the previous paragraph, precision is further improved if the computation sequence is as follows: First, the reduced argument C (YBⱼ−1) is computed as a pair of working-precision components Zₕᵢ and Zₗₒ such that their sum approximates Z to higher than working-precision. In addition, they add up to Z exactly (without roundoff error) when j=0 and j=N. Second, kLₕᵢ+T_{j,hi}+Zₕᵢ should be representable exactly in working-precision for all valid values of k, j, and Z. This means that the components in the actual Reconstruction operation 216 include A₁=kLₕᵢ+T_{j,hi}+Zₕᵢ, and A₂=kLₗₒ+T_{j,lo}+P(Z). The actual high accuracy computation is depicted in FIG. 2 as a single program flow of operations 204-216 in which the index j has been dropped for clarity.

Referring to FIG. 2, it might at first appear that there is conditional code (and thus perhaps a test and branch instruction) in the Reconstruction operation 216, since there are two different additions, depending on whether kLₕᵢ+T_{j,hi}=kLₗₒ+T_{j,lo}=0, or otherwise. However in reality the different additions in operation 216 can be implemented in the same way except for different placements of the Zₗₒ term. This different placement can be implemented with conditional data movements which do not require test and branch instructions.

### EXAMPLE

Natural Logarithm

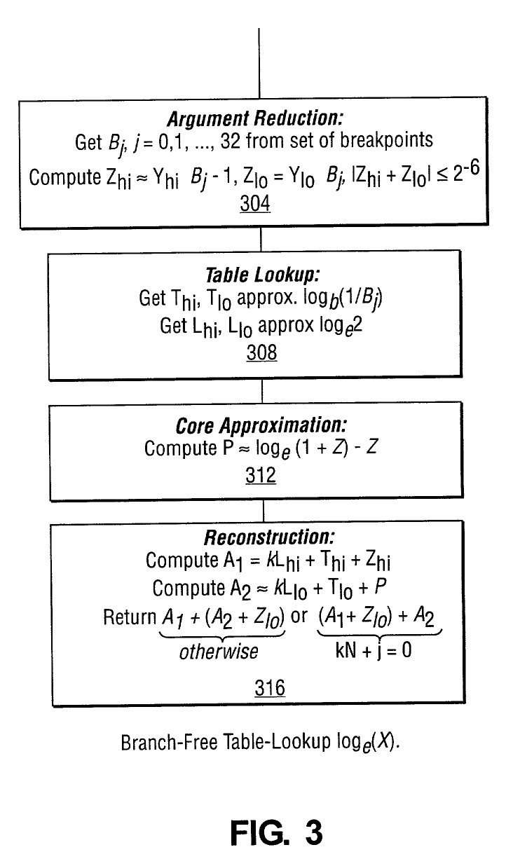

The following is a specific realization of the computation of a natural logarithm function in double precision. A flow diagram for this embodiment has operations 304, 308, 312, and 316 in FIG. 3. The operations 304-316 may be generally similar to 204-216 of FIG. 2, except that the logarithm is for base e.

Breakpoint Definition and Argument Reduction: Let the input argument be

X=2^{k}×Y,Y=1. y₁y₂y₃y₄y₅y₆ . . . y_{L}=1+i/32+beta, 0≦beta<1/32.

Define the auxiliary values F=1+i/32 if beta<1/64, and F=1+(i+1)/32 if beta≧1/64. Hence, F=1+j/32=Fⱼ, j=0, 1, . . . , 32. Define the breakpoints Bⱼ=1/Fⱼ rounded to finite precision with 10 significant bits. Recall that B₀=1 and B₃₂=1/2. Note that the index j is really given by [y₁y₂y₃y₄y₅]+y₆. By masking of binary bits, decompose Y into two working-precision variables Yₕᵢ and Yₗₒ where Yₕᵢ is Y with the lower 32 significant bits set to zero. C is 1 in this case. The several components of the reduced arguments are computed as Zₕᵢ←YₕᵢBⱼ−1, Zₗₒ←YₗₒBⱼ, Z←Zₕᵢ+Zₗₒ.

Table Value Calculations: The leading parts of Tₕᵢ and Lₕᵢ of the table values are all obtained by rounding the ideal values to a precision such that the least significant bit is 2⁻⁴³. Hence, Lₕᵢ=logₑ2 is rounded to 1 sb at 2⁻⁴², and T_{j,hi}=log_{b}(1/Bⱼ) is similarity rounded. The trailing parts are simply the working-precision approximation of the differences between the ideal values and the leading values. Hence Lₗₒ=logₑ2−Lₕᵢ is rounded to 53 significant bits, and T_{j,lo}=logₑ(1/Bⱼ)−T_{j,hi} is rounded to 53 significant bits.

### EXAMPLE

Base 10 Logarithm

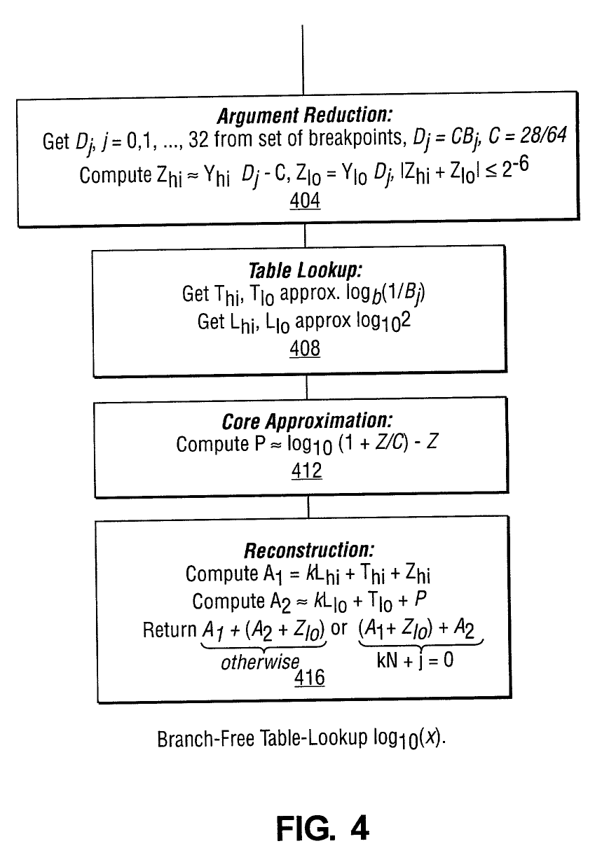

An embodiment of the branch-free methodology for the base-10 logarithm function is as follows. See also the flow diagram in FIG. 4 in which operations 404, 408, 412, and 416 are depicted.

Breakpoint Definition and Argument Reduction: Let the input argument be

X=2^{k}×Y,Y=1.y₁y₂y₃y₄y₅y₆. . . y_{L}=1+i/32+beta, 0, beta≦1/32.

Define the auxiliary values F=1+i/32 if beta<1/64, and F=1+(i+1)/32 if beta≦1/64. Hence F=1+j/32=Fⱼ, j=0, 1, . . . , 32. Define the breakpoints Bⱼ=1/Fⱼ rounded to finite precision with 10 significant bits. Recall that B₀=1 and B₃₂=1/2. Note that the index j is really given by [y₁y₂y₃y₄y₅]+y₆. By masking of binary bits, decompose Y into two working-precision variables Yₕᵢ and Yₗₒ where Yₕᵢ is Y with the lower 32 significant bits set to zero. Pick C to be 28/64 in this case, which is a 5-significant-bit approximation of log₁₀(e). Instead of storing Bⱼ, store the values Dⱼ=CBⱼ, j=0, 1, . . . , 32. The several components of the reduced arguments are computed as Zₕᵢ←YₕᵢDⱼ−C, Zₗₒ←YₗₒDⱼ, Z←Zₕᵢ+Zₗₒ.

Table Value Calculations: The leading parts of the table values are all obtained by rounding the ideal values to a precision such that the least significant bit is 2⁻⁴³. Hence, Lₕᵢ=logₑ2 rounded to 1 sb at 2⁻⁴³ and T_{j,hi}=log_{b}(1/Bⱼ) is similarly rounded. The trailing parts are simply the working-precision approximation of the differences between the ideal values and the leading values. Hence Lₗₒ=logₑ2−L. rounded to 53 significant bits, and T_{j,lo}=logₑ(1/Bⱼ)−T_{j,hi} rounded to 53 significant bits.

The various embodiments of the branch-free methodology described above avoid the conventional numerical problems of table-lookup techniques which occur near the root of the transcendental function. Since there are a relatively small number of table values that create this numerical imprecision near the root of the transcendental function, where in the above examples it was one or both of the endpoint values B₀ and B_{N}, the branch-free methodology ensures that these small number of values are exact, such that no roundoff errors are present. For instance, in the case of the logarithm function, this was insured by setting B₀=1 such that the table value is 0. Alternatively, this could be insured by setting B_{N}=1/2 and the table value there is exactly that stored for log_{b}(2) such that the terms in the approximate function that include B_{N} and log_{b}2 cancel each other when k=−1, leading to exactness. The approximate function estimates the desired transcendental function using a reduced argument, in a small region around the root of the transcendental function. For instance, in the case of the logarithm function, the reduced argument is Z=C(YBⱼ−1). Moreover, for highest accuracy, this reduced argument should be computed to an accuracy higher than that of working precision. Thus, in the case of the logarithm function, this can be obtained by computing the reduced argument as components Zₕᵢ and Zₗₒ. In addition, to obtain the highest accuracy, the components should be combined with the table values in a way that preserves the extra accuracy that was computed for the reduced argument. Again, in the case of the logarithm function, this may be insured by arranging the value kLₕᵢ+Tₕᵢ+Zₕᵢ to be exactly representable.

The concepts of the various embodiments of the branch-free methodologies described above are also applicable to other transcendental functions. One example is the computation of the function exp (X)−1 over a small range around its root, 0. In that case, an exemplary set of table values would correspond to exp (j/2^{m}) for some m. The reduced argument of the approximate function in this case would have the form X−(j log²)/2^{m}.

Another example for computing a transcendental function using the branch-free software methodology is the computation of atan (X). Here, the table values can be atan (B) for some breakpoint B that approximates X. The reduced argument of the approximate function can be of the form Z=(X−B)/(1+BX).

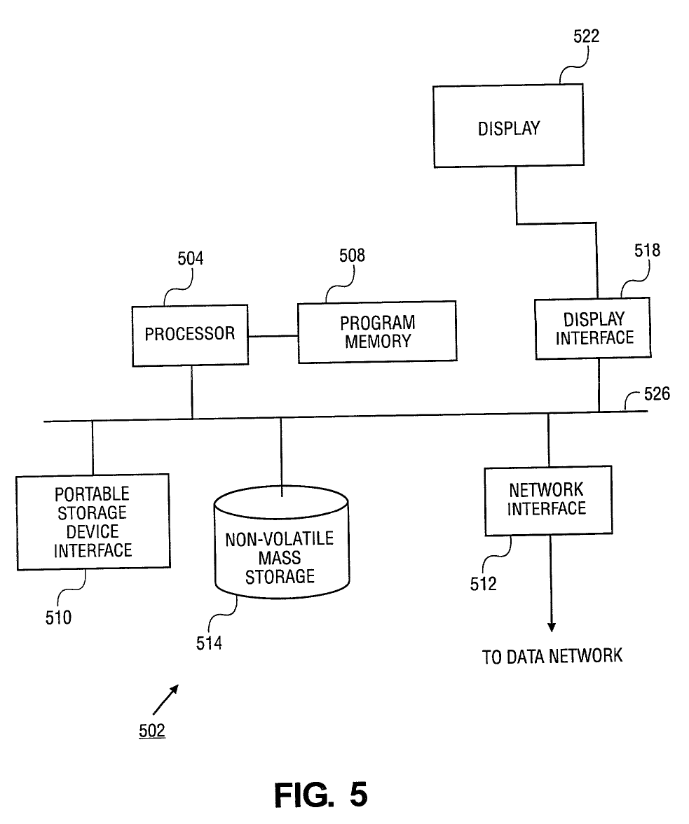

FIG. 5 shows a block diagram of a computer system 502 that may be configured with instructions that when executed by a processor approximate a transcendental function according to the branch-free methodology. The system 502 features a processor 504 that is coupled to a nonvolatile mass storage device 514 via a bus 526. The mass storage device 514 may be a conventional rotating magnetic disk drive or other nonvolatile memory for storing program instructions and data to be executed by the processor 504. Instructions and data are normally transferred to program memory 508, which may be a higher speed, volatile memory such as dynamic random access memory (DRAM), as they are executed by the processor 504. The results of the execution may be displayed using a display 522, such as a cathode ray tube (CRT) or other visual display device, accessed via a display interface 518. In addition, the results of the program execution may be transferred out to a data network via a network interface 512. The program instructions and data for the branch-free software methodology are introduced into the system 502 via either the network interface 512 or through a portable storage device interface 510. The latter acts as an interface to a storage medium such as a compact disc read only memory (CD-ROM) or other portable, nonvolatile storage device.

As mentioned above, the branch-free software methodology for computing a transcendental function would normally be written in assembly language code that is specific to the processor 504 of the system 502 (see FIG. 5). The assembly language code may be sold as part of a compiler program to translate higher level programs, written in a particular source code, into machine code for the particular processor 504. The compiler program would include an operation in which the source code is parsed according to conventional techniques and a reference to a transcendental function is detected. The compiler may then replace all instances of this high level function call by a sequence of assembly language instructions that implement the appropriate branch-free methodology for that transcendental function.

To summarize, various embodiments of a branch-free methodology for computing a transcendental function have been described. In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A computer-implemented method for approximating a function of an input argument, comprising:
selecting one of a plurality of breakpoints, such that a reduced argument for the function is less than a predetermined value; and
evaluating an approximate function of the reduced argument, including accessing a look-up table based on the selected breakpoint to obtain a value of a term in the approximate function,
wherein the look-up table has at least one breakpoint for which the reduced argument can be computed without roundoff error when the input argument is close to a root of the function.

2. The method of claim 1 wherein the function is log_{b}(X).

3. The method of claim 2 further comprising:
representing X in the floating point form Y*G^{k} where Y is greater than or equal to 1, and wherein the reduced argument is Z=C*(Y*Bⱼ−1) where C is a function of log_{b}(e), and evaluating the approximate function includes determining log_{b}(1/B,) using the look-up table and determining log_{b}(X) as an arithmetic combination of at least k*log_{b}(2), log_{b}(1/Bⱼ), and log_{b}(1+Z/C).

4. The method of claim 3 wherein Y<=2 and the look-up table is modified such that B₀=1 and B_{N}=1/2.

5. The method of claim 3 wherein log_{b}(1/Bⱼ) is given by the look-up table as at least two lower precision values T_{j,hi} and T_{j,lo} whose sum equals log_{b}(1/Bⱼ), log_{b}(2) is given by at least two lower precision values Lₕᵢ. and Lₗₒ whose sum equals log_{b}(2), and Z is given by at least two lower precision values Zₕᵢ and Zₗₒ whose sum equals Z.

6. The method of claim 5 wherein log_{b}(X) is approximated by A₁+A₂+Zₗₒ, where A₁ is k*Lₕᵢ+T_{j,hi}+Zₕᵢ, A₂ is k*Lₗₒ+T_{j,lo}+P and P is log_{b}(1+Z/C)−Z.

7. The method of claim 6 wherein if k*N+j=0 for the breakpoint, then log_{b}(X) is approximated by (A₁+Zₗₒ)+A₂.

8. The method of claim 7 wherein log_{b}(X) is otherwise given by A₁+(A₂+Zₗₒ).

9. The method of claim 3 wherein the predetermined value is proportional to 1/(2*N).

10. The method of claim 9 wherein k*Lₕᵢ+T_{j,hi} can be represented without roundoff error for all valid values of k,j.

11. The method of claim 10 wherein T_{0,hi}=T_{0,lo,}=0 and T_{N,hi}=Lₕᵢ, T_{N,lo}=Lₗₒ.

12. An article of manufacture, comprising:
a machine readable medium having instructions stored therein that can be executed by a processor to approximate a function of an input argument by selecting one of a plurality of breakpoints, such that a reduced argument for the function is less than a predetermined value, and evaluating an approximate function of the reduced argument including accessing a look-up table based on the selected breakpoint to obtain a value of a term in the approximate function, wherein the look-up table has at least one breakpoint for which the reduced argument can be computed without roundoff error when the input argument is close to a root of the function.

13. The article of manufacture of claim 12 wherein the function is log_{b}(X).

14. The article of manufacture of claim 13 wherein the medium has further instructions for representing X in the floating point form Y*G^{k} where Y is greater than or equal to 1, and wherein the reduced argument is Z=C*(Y*Bⱼ−1) where C is a function of log_{b}(e), and evaluating the approximate function includes determining log_{b}(1/Bⱼ) using the look-up table and determining log_{b}(X) as an arithmetic combination of at least k*log_{b}(2), log_{b}(1/Bⱼ), and log_{b}(1+Z/C).

15. The article of manufacture of claim 14 wherein Y<=2 and the look-up table is modified such that B₀=1 and B_{N}=1/2.

16. The article of manufacture of claim 13 wherein log_{b}(1/Bⱼ) is given by the look-up table as at least two lower precision values T_{j,hi} and T_{j,lo} whose sum equals log_{b}(1/Bⱼ), log_{b}(2) is given by at least two lower precision values Lₕᵢ and Lₗₒ whose sum equals log_{b}(2), and Z is given by at least two lower precision values Zₕᵢ and Zₗₒ whose sum equals Z.

17. The article of manufacture of claim 16 wherein log_{b}(X) is approximated by A₁+A₂+Zₗₒ, where A₁ is k*Lₕᵢ+T_{j,hi}+Zₕᵢ, A₂ is k*Lₗₒ+T_{j,lo}+P and P is log_{b}(1+Z/C)−Z.

18. The article of manufacture of claim 17 wherein if k*N+j=0 for the breakpoint, then log_{b}(X) is approximated by (A₁+Zₗₒ)+A₂.

19. The article of manufacture of claim 18 wherein log_{b}(X) is otherwise given by A₁+(A₂+Zₗₒ).

20. The article of manufacture of claim 14 wherein the predetermined value is proportional to 1/(2*N).

21. The article of manufacture of claim 20 wherein k*Lₕᵢ+T_{j,hi} can be represented without roundoff error for all valid values of k,j.

22. The article of manufacture of claim 21 wherein T_{0,hi}=T_{0,lo}=0 and T_{N,hi}=Lₕᵢ, T_{N,lo}=Lₗₒ.

23. A computer system comprising:
a processor coupled to a non-volatile storage device, the storage device contains instructions that when executed by the processor approximate a function of a number, by selecting one of a plurality of breakpoints, such that a reduced argument for the function is less than a predetermined value, and evaluating an approximate function of the reduced argument including accessing a look-up table based on the selected breakpoint to obtain a value of a term in the approximate function, wherein the look-up table has at least one breakpoint for which the reduced argument can be computed without roundoff error when the input argument is close to a root of the function.

24. The computer system of claim 23 wherein the function is log_{b}(X).

25. The computer system of claim 24 wherein the storage device has further instructions that when executed by the processor represent X in the floating point form Y*G^{k} where Y is greater than or equal to 1, and wherein the reduced argument is Z=C*(Y*Bⱼ−1) where C is a function of log_{b}(e), and evaluating the approximate function includes determining log_{b}(1/Bⱼ) using the look-up table and determining log_{b}(X) as an arithmetic combination of at least k*log_{b}(2), log_{b}(1/Bⱼ), and log_{b}(1+Z/C).

26. The computer system of claim 25 wherein log_{b}(1/Bⱼ) is given by the look-up table as at least two lower precision values T_{j,hi} and T_{j,lo} whose sum equals log_{b}(1/Bⱼ), log_{b}(2) is given by at least two lower precision values Lₕᵢ and Lₗₒ whose sum equals log_{b}(2), and Z is given by at least two lower precision values Zₕᵢ and Zₗₒ whose sum equals Z.

27. The computer system of claim 26 wherein log_{b}(X) is approximated by A₁+A₂+Zₗₒ, where A₁ is k*Lₕᵢ+T_{j,hi}+Zₕᵢ, A₂ is k*Lₗₒ+T_{j,lo}+P and P is log_{b}(1+Z/C)−Z.

28. The computer system of claim 23 wherein the processor has a hardware architecture that is deeply pipelined and in which branch mispredictions cause a significant performance penalty.

29. The computer system of claim 28 wherein the processor is one of a plurality of IA-32 series of processors by Intel Corp.
